(19) United States
(12) Patent Application Publication
(10) Pub. No.: US 2022/0398345 A1
(43) Pub. Date: Dec. 15, 2022

(54) TRANSPARENT REPORTING AND CONTROL OF PERSONAL DATA USED TO DELIVER TARGETED CONTENT

(71) Applicant: Microsoft Technology Licensing, LLC, Redmond, WA (US)

(72) Inventors: Lillian Rachel KRAVITZ, Seattle, WA (US); Nadya AMIRCHOUPANI, Kirkland, WA (US); Melanie Elizabeth RICHARDS, Seattle, WA (US); Edward Arthur Scott LOW, Redmond, WA (US); Kyle Blair RISAN, Fall City, WA (US)

(21) Appl. No.: 17/344,591

(22) Filed: Jun. 10, 2021

(51) Int. Cl. G06F 21/62; G06F 3/0482; G06F 3/0484

(52) U.S. Cl. CPC G06F 21/6263; G06F 3/0482; G06F 3/0484

(57) ABSTRACT

An application programming interface (API) is provided to an application configured to cause display of a user interface (UI). An item of targeted content and metadata corresponding to the item of targeted content is received. The item is rendered in the UI and a call to the API is initiated based on the metadata, the call causing the UI to render a UI feature concurrently within the item. Interaction with the UI feature causes the application to display additional UI features that identify the provider of the item and user information it possesses, the information comprising a reason for the item being provided. Further UI features may be rendered that enable a user to manage such information. In another aspect, the application may comprise a web browser and UI features rendered using the API may comprise a tracker information UI that enables the user to control use of browser trackers.

### BACKGROUND

Targeted content is commonly presented to users through web browsers running on personal computers, tablets, or other mobile devices. Targeted content is also commonly delivered and presented to users through other types of applications (e.g., smart phone or tablet apps) that are made available to users for free in exchange for periodically viewing such targeted content. In either situation, it is increasingly common for such targeted content to be personally directed to a user based on known or inferred information that content providers may have regarding a user. For example, targeted content may be selected by a content provider based on geo location of the user, a prior website visit, or characteristics of the user that may have been gathered or inferred by one or more content providers or other parties. For example, user characteristics may include gender, age group, career/employer, work industry, income bracket, life stage, interests/hobbies, prior purchases and/or web page or app context. Increasingly, users are demanding more privacy and control over how information about them is gathered and used.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are described herein that enable users to have visibility into how data regarding the users is collected and used, and provide control over such data.

In one aspect, an application is configured to cause display of a user interface on a display device and an application programming interface (API) is provided. An item of targeted content and metadata corresponding to the item of targeted content is received. The item of targeted content is rendered in the UI (user interface) and a call to the API is initiated based on the item of targeted content metadata. The call causes the UI to render a content transparency UI feature concurrently within the rendered item of targeted content. In a further aspect, interaction by a user with the content transparency UI feature causes the application to display one or more additional UI features that identify the provider of the item of targeted content and information known or inferred about the user that was a factor or reason for the item of targeted content being provided. In additional aspects, further UI features may be rendered using the API that enable the user to manage such information known or inferred about the user. In another aspect, the application may comprise a web browser, and UI features rendered using the API may comprise a tracker information UI that enables the user to control use of browser trackers.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 depicts an example targeted content delivery system configured to provide an item of targeted content to an application, according to an embodiment.

FIG. 2 depicts a flowchart of an example method for using a content transparency application programming interface (API) to render a user interface (UI) that includes UI features, according to an embodiment.

FIG. 3 depicts an example web page rendered via a content transparency API to include UI features, according to an embodiment.

FIG. 4 depicts an example web page rendered to include a content provider information UI, according to an embodiment.

FIG. 5 depicts an example web page rendered to include a tracker information UI, according to an embodiment.

FIG. 6 depicts an example web page rendered to include UI features for controlling allowed trackers, according to an embodiment.

FIG. 7 depicts an example web page rendered comprising a detailed tracker information UI, according to an embodiment.

FIG. 8 is a block diagram of an example mobile device that may implement embodiments described herein.

FIG. 9 is a block diagram of an example computer system in which embodiments may be implemented.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. INTRODUCTION

The present specification and accompanying drawings disclose numerous embodiments. The scope of the present patent application is not limited to the disclosed embodiments which are merely exemplary. Accordingly, the present patent application also combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. EXAMPLE EMBODIMENTS

Users of mobile devices, tablets, PCs, and the like, generally report dissatisfaction with online privacy. In some cases, the dissatisfaction relates to targeted content. “Targeted content” is content targeted specifically to a user based on an association between the content and particular attributes of the user, such as profile information related to the user (e.g., demographic information such as gender, age, ethnicity, income level), a location of the user, preferences/interests of the user, lifestyle aspects of the user, employment type of the user, etc. Examples of targeted content include advertisements, electronic coupons (e.g., E-coupons) or offers, tailored offers of free content, creative content (e.g., text, audio, images, multimedia), and/or other types of personalized content. For instance, web browsers and other types of applications oftentimes deliver advertisements to users that many such users deem to be “creepy”. That is, advertisements that “follow them” across the web. For example, it is not uncommon for one user in a household to start seeing advertisements based on browsing that another user in the household may be doing. Likewise, a user shopping for a certain product on a smartphone or tablet may find it unseemly to instantly start seeing advertisements for such products after switching to using a desktop computer for unrelated browsing. Tracking mechanisms in web browsers often enable these types of undesired behaviors.

In an effort to address these objections, some web browsers have been developed to include built-in tracker blocking functionality. For example, the Microsoft Edge® browser may be configured to perform tracking prevention using pre-set formulas of various strictness. Although users report some satisfaction with the feature, additional transparency regarding trackers and content transparency is desired.

Third-parties that use browser trackers for advertisements or other targeted content purposes and/or are otherwise involved in providing targeted content to users may wish to act as “transparent content providers” for a variety of reasons, including adherence to organizational and/or community principles that encourage transparency, privacy control, and/or other values; participation in business transactions that provide value at least in part for acting as a transparent content provider; and numerous other reasons.

Embodiments expose a targeted content transparency API (application programming interface) (also referred to as a “content transparency API”) that, in conjunction with metadata received from transparent content providers (also referred to as “content provider metadata,” such as “ad provider metadata”), may cause generation of a user interface (“UI”) (as part of a rendered web page, or in conjunction with one or more other applications) that indicates which third-party trackers correspond to transparent content providers, discloses known or inferred information about a user that motivated the presentation of a particular item of targeted content, gives users the ability to opt out of the collection of such data, and allows users to correct or delete any such data already associated with a given content provider/tracker stored in the browser.

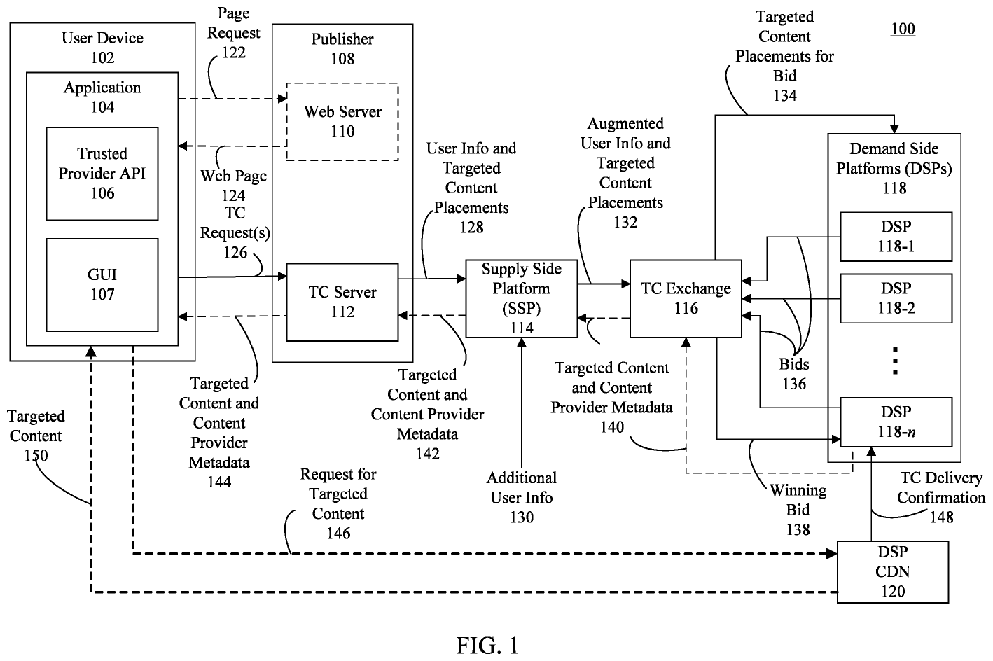

These features, and others, of the disclosed embodiments are further described as follows with reference to FIG. 1. FIG. 1 depicts an example targeted content delivery system 100 for providing an item of targeted content to an application, according to an embodiment. As shown in FIG. 1, targeted content delivery system 100 includes a user device 102, a publisher 108, a supply side platform 114, a targeted content (TC) (e.g., advertisement or “ad”) exchange 116, a DSP (demand side platform) CDN (content delivery network) 120 and demand side platforms 118. User device 102 includes an application 104 that includes a trusted provider API 106 and a GUI (graphical user interface) 107. Publisher 108 includes a targeted content (TC) server 112 (e.g., an ad server) and in some embodiments, may include web server 110. Demand side platforms 118 include DSPs 118-1 to 118-n. Other structural and operational embodiments will be apparent to persons skilled in the relevant art(s) based on the following discussion regarding targeted content delivery system 100 as depicted in FIG. 1.

The interconnections between each of publisher 108, supply side platform 114, TC exchange 116, DSP CDN 120, and demand side platforms 118 as depicted in FIG. 1 are intended to represent network interconnections. In an embodiment, such network connections are made via the Internet. However, portions of the depicted connections may utilize other networks such as one or more networks such as local area networks (LANs), wide area networks (WANs), enterprise networks, and may include one or more of wired and/or wireless portions.

Moreover, although each of publisher 108, supply side platform 114, TC exchange 116, DSP CDN 120, and demand side platforms 118 in FIG. 1 are depicted as monolithic components, it should be understood that such components may be embodied in any number of computing devices including servers, and may include any type and number of other resources, including resources that facilitate communications with and between computing devices connected via one of the aforementioned networks. In embodiments, servers implementing these components may be organized in any manner, including being grouped in server racks (e.g., 8-40 servers per rack, referred to as nodes or “blade servers”), server clusters (e.g., 2-64 servers, 4-8 racks), or datacenters (e.g., thousands of servers, hundreds of racks, dozens of clusters). In an embodiment, the servers of may be co-located (e.g., housed in one or more nearby buildings with associated components such as backup power supplies, redundant data communications, environmental controls) to form a datacenter, or may be arranged in other manners. Accordingly, in an embodiment, one or more of publisher 108, supply side platform 114, TC exchange 116, DSP CDN 120, and demand side platforms 118 may comprise a datacenter in a distributed collection of datacenters.

Although TC server 112 is depicted as being a component or part of publisher 108 in FIG. 1, it should be understood, that TC server 112 may be physically located at any facility of publisher 108, in an embodiment. In another embodiment, TC server 112 need not be housed or even directly controlled by publisher 108, but may instead comprise one or more servers of a third-party acting as an agent or contractor of publisher 108.

Embodiments of targeted content delivery system 100 are configured to provide targeted content and content provider metadata from one or more transparent content providers, such as a transparent ad provider, to application 104 executing on user device 102, where application 104 is configured to thereafter enable content transparency and control UI features based on the content provider metadata, and as will be described further herein. Embodiments of user device 102 may include any type of mobile computer or computing device such as a handheld device (e.g., a Palm® device, a RIM Blackberry® device, a personal digital assistant (PDA)), a laptop computer, a notebook computer, a tablet computer (e.g., an Apple iPad™, a Microsoft Surface™), a netbook, a mobile phone (e.g., a smart phone such as an Apple iPhone, a Google Android™ phone, a Microsoft Windows® phone), a wearable device (e.g., virtual reality glasses, helmets, and visors, a wristwatch (e.g., an Apple Watch®)), and other types of mobile devices. In further embodiments, computing device 102 may be stationary computer or computing device, such as a desktop computer.

Application 104 of targeted content delivery system 100 of FIG. 1 may include, for example, a web browser. Indeed, embodiments described herein are couched in terms of a web browser and typical web browser operation. However, embodiments are not limited to a web browser. As known in the art, numerous other types of applications or mobile apps are capable of receiving and displaying targeted content in a UI on a display screen of user device 102. Accordingly, embodiments may be configured to operate with applications other than a web browser.

For example, and as described briefly herein above, many applications (particularly mobile apps) employ a business model whereby an app may be provided by a publisher for free or at a reduced cost provided that the user views targeted content from time to time while using the app. Because application 104 need not comprise a web browser, web server 110 of publisher 108 is depicted in targeted content delivery system 100 of FIG. 1 with a dashed line to denote that web server 110 is optional, and applicable to embodiments in which application 104 comprises a web server. For illustrative purposes only, further description of targeted content delivery system 100 of FIG. 1 is based on embodiments in which application 104 of user device 102 is a web browser. With that in mind, a description of publisher 108 follows below.

Publisher 108 includes web server 110 and TC server 112. Publisher 108 may comprise, for example, any publisher of web content of any kind. Typical and well-known examples may include news websites (e.g., www.cnn.com or www.msnbc.com), sports websites (e.g., www.espn.com) or social media websites (e.g., www.facebook.com or www.twitter.com). A user of user device 102 may, for example, use a URL associated with one of the above listed websites to navigate to the corresponding website by sending page request 122 to web server 110. Web server 110 subsequently responds by sending web page 124 to application 104 of user device 102 for rendering and display thereon.

In an embodiment, web page 124 does not include targeted content, but instead includes placeholders for targeted content yet to be retrieved, and further includes a URL or other navigable link operable to initiate delivery of the targeted content, such as a targeted content creative, necessary to fill in the placeholders and properly render web page 124 with targeted content inserted. A targeted content creative is an object or structure that contains data for visually rendering the targeted content. Application 104 is configured to use such a URL to form targeted content (TC) request(s) 126 (e.g., ad request(s)) which are sent to TC server 112, which may be configured to respond differently in different embodiments. For example, TC server 112 may in some cases have suitable targeted content (e.g., in the form of ad creatives when TC server 112 is an ad server) that it may serve directly to application 104 for placement within web page 124. Alternatively, TC server 112 may instead request targeted content from another source such as, for example, supply side platform 114. In the latter instance, TC server 112 is configured to provide user information and targeted content placements 128 (e.g., targeted content locations/slot being made available) to supply side platform 114. In an embodiment, user information and targeted content placements 128 may be generated by TC server 112 by bundling together one or more targeted content requests 126 along with information that publisher 108 may know or infer about the user of user device 102.

For example, publisher 108 may have demographic or other information corresponding to the user including, but not limited to, their address, gender, age, income, hobbies, browser history (i.e., navigation history within websites provided by publisher 108), purchasing history, and the like. Publisher 108 may collect such information at various times and in various ways. For example, some of these types of information may be provided to publisher 108 when the user creates an account and/or fills out their profile (e.g., a social media account). Likewise, publisher 108 may own or be affiliated with a number of websites that share information among one another. No matter how collected, such information may subsequently form the basis for the decision to buy the right to present that user with targeted content. Such information, along with identifying information publisher 108 has regarding the user, is bundled with one or more offers and sent to supply side platform 114 as user information and targeted content placements 128.

Supply side platform 114 is so named because it manages a supply of content slots that targeted content providers may wish to use for their targeted content. That is, publisher 108 is offering content space for sale, so they are considered the supplier, and supply side platform 114 manages that supply on behalf of publisher 108. In an embodiment, supply side platform 114 may use identifying information in user information and targeted content placements 128 to gather additional user information 130. For example, supply side platform 114 may have or have access to a database to look up additional demographic information, previous purchases, and/or other information of interest to targeted content providers about that user. Such information serves to augment the information already provided in user information and targeted content placements 128, and offers the purchasers of content slots a more complete picture of who would receive and view their targeted content.

Supply side platform 114 is configured to obtain different types of information, as available, about a user. These types of data may be referred to as first party, second party and third-party data. First party data comprises data collected directly from the users of the websites controlled by publisher 108. For example, first party data can include data from customer behaviors, actions or interests. In an embodiment, supply side platform 114 is configured to manage the first party data collected by publisher 108. Second party data refers to first party data of some other entity that publisher 108 obtains directly from that entity. For example, publisher 108 may be able to contract with a large social media company for the information that it has or can infer about its users. Third party data is data about users that may be purchased from data aggregators. Data aggregators may collect data about users in numerous ways, but typically pay publishes or other data owners for their first party data.

After supply side platform 114 collects additional user information 130 about the user of user device 102, such information is added to user information and targeted content placements 128 and passed to TC exchange 116 as augmented user information and targeted content placements 132.

In an advertising embodiment, TC exchange 116 comprises a broker that manages a market that puts sellers in touch with buyers by providing, for example, an auction platform. That is, TC exchange 116 accepts augmented user information and targeted content placements 132, in the form of user information and targeted content offers, from supply side platform 114, and finds a buyer for targeted content placements 132 by putting such offers out for bid to each of the n demand side platforms 118-1 through 118-n of demand side platforms 118.

In such an embodiment, demand side platforms 118 act on behalf of targeted content agencies, who sell targeted content slots to companies that wish to make targeted content placements. Thus, demand side platforms 118 each have targeted content (e.g., ad content/ad creatives) that are ready and waiting for display within, for example, a web page. Demand side platforms 118 are so named because they manage the demand for targeted content placements. As part of targeted content placements for bid 134 (e.g., ad offers for bid), each of demand side platforms 118 receives the augmented user information and targeted content placements 132 (i.e., the information about the user ready to view the targeted content), and each demand side platform determines how much they would be willing to pay to have their content viewed by this particular user, and then submits bids 136 to TC exchange 116. The highest bid wins, and TC exchange 116 informs the winning demand side platform of demand side platforms 118 (in this example, DSP 118-n) that they won the auction (via winning bid 138), and that they should provide the targeted content creatives (whether directly or indirectly) to user device 102 for display in GUI 107 of application 104.

Targeted content may be delivered to application 104 of user device 102 in a number of ways, two of which are depicted in FIG. 1. First, the winning demand side platform (DSP 118-n in this instance) may directly provide a targeted content creative to TC exchange 116 as part of targeted content and content provider metadata 140 which is relayed in turn back through supply side platform 114 to TC server 112 (as part of targeted content and content provider metadata 142) where the targeted content creative is served to application 104 of user device 102 (as part of targeted content and content provider metadata 144). Note that in FIG. 1, each step along the path from TC exchange 116 to application 104 of user device 102 is denoted by dashed lines.

Alternatively, DSP 118-n may instead provide a link to a targeted content creative that is hosted elsewhere. For example, DSP 118-n may include a link to a targeted content creative that is managed by a CDN such as DSP CDN 120. In an embodiment, DSP CDN 120 comprises a third party that is paid by DSP 118-n to store and serve its targeted content creatives. The link provided by DSP 118-n to TC exchange 116 is again transferred back through supply side platform 114 to TC server 112 where the link is delivered to application 104 of user device 102. As with the directly delivered targeted content creative, the link supplied by DSP 118-n is included in targeted content and content provider metadata 140 as well as targeted content and content provider metadata 142 and targeted content and content provider metadata 144. Note that in FIG. 1, the path comprising the request for, and return of, targeted content is denoted by a dotted line. In this instance where application 104 of user device 102 uses the link to generate and send request for targeted content 146 to DSP CDN 120, and receives targeted content 150 in return, DSP CDN 120 may thereafter provide targeted content delivery confirmation 148 (e.g., an ad delivery confirmation) to DSP 118-n.

No matter the manner of delivery, application 104 of user device 102 may insert targeted content 150 into position within the web page being rendered in GUI 107. Each of targeted content and content provider metadata 140, 142 and 144 may differ with respect to the content provider metadata included therein, and as will be described in further detail herein below.

A “targeted content provider” may be any entity that played a role in delivering an item of targeted content (e.g., an advertisement) and for which information about the user formed a basis for the decision to do so. For example, there was some aspect or attribute of the user of user device 102 that DSP 118-n found valuable enough to place the winning bid. Suppose for example that the user of user device 102 navigated to a website with instructions about how to change the oil in their car, and that the user had previously purchased motor oil online. Such information would be incorporated into augmented user information and targeted content placements 132 and provided to DSP 118-n as part of targeted content placements for bid 134. Then, and further supposing that DSP 118-n is an oil filter company, DSP 118-n might reasonably infer that the user is soon going to change the oil in a car, and that an advertisement for the oil filter company's oil filters placed on that page would be valuable and, at least in part on that basis, submitted the highest bid for that advertisement slot. In this example, and further supposing that DSP 118-n is a trusted provider as described above, DSP 118-n provides as part of targeted content and content provider metadata 140 metadata that indicates that the browser context and shopping history of the user formed a reason why the advertisement (or link thereto) was provided for display in the browser.

Not every targeted content provider in the chain of delivery need be a trusted content provider. Each trusted content provider in the chain of content delivery that relies on information regarding the user of user device 102 must also generate and deliver such metadata. If a content provider is not trusted, then it need not provide the metadata. For example, suppose that TC exchange 116 is a trusted content provider, put out targeted content placements for bid 134 to only a subset of the available demand side platforms 118, and did so because the user was in a certain geographic location. In that instance, the content provider metadata must be generated and included in targeted content and content provider metadata 140 that is provided to supply side platform 114. Likewise, if supply side platform 114 is a trusted provider and user information provided the basis for any decision made by supply side platform 114, then provider metadata will be included in targeted content and content provider metadata 142. Finally, TC server 112 may likewise have decided to send out user information and targeted content placements 128 to supply side platform 114 rather than deliver its own locally stored targeted content, and the decision to do so may have been based on user-related factors. In such an instance, and where publisher 108 is a trusted provider, targeted content and content provider metadata 144 will incorporate provider metadata that discloses the particular user information that was relied upon. Thus, in the end, it may be the case that targeted content and content provider metadata 144 includes provider metadata regarding all of DSP 118-n, TC exchange 116, supply side platform 114 and TC server 112.

Such provider metadata may be generated and delivered in various ways. For example, a content provider may generate a metadata structure and insert same as a meta tag into the document object model (DOM) of the targeted content creative that is delivered to application 104 of user device 102. Alternatively, the meta tag may be inserted into a parent document that hosts the targeted content creative. In an embodiment, such a metadata structure may conform to a JSON schema. For example, consider the example provider metadata schema (Example JSON Provider Metadata Schema) shown below:

```
{
  “atps”: [ {
    “idType” : “IAB_GVL_ID”,
    “id” : 2,
    “name”: “Supply-Side Platform Name”
  }, {
  “idType”: “IAB_GVL_ID”,
  “id”: 3,
  “name”: “Another Supply-Side Platform Name, If Applicable”
  } ],
  “targetedcontentPlatform” : {
    “idType”: “IAB_GVL_ID”,
    “id”: 1,
    “name”: “Demand-Side Platform Name″
  },
  “salecategory”: {
    “device”: “DEVICE_USED”,
    “geoLocation”: “GEO_LOCATION_APPROXIMATE”,
    “context”: “CONTEXT_USED”,
    “other”: “OTHER_NOT_USED”
  },
    “targetingcategory”: {
      “geoLocat ion”: “GEO_LOCATION_APPROXIMATE”,
      “remarketing”: “REMARKETING_WEBSITE_VISIT”,
      “userinterests”: “USER_INTERESTS_USED”,
      “usercharacteristics”: [ “USER_CHARACTERISTICS_GENDER”,
      “USER_CHARACTERISTICS_AGE_GROUP”, “USER_CHARACTERISTIC_LIFE_STAGE” ],
      “context”: “CONTEXT_USED”,
      “lookalike”: “LOOKALIKE_SIMILAR_AUDIENCE”,
      “other”: “OTHER_NOT_USED”
  },
  “targetedcontentInstances” : [{
    “id”: “123456789”,
    “targetedcontentDomain” : “adomainvalue.comv,
    “targetedcontentName”: “Brand Name”,
    “type”: “BANNER”
  }, {
    “id”: “54098375390”,
    “targetedcontentDomain”: “contoso.com”,
    “targetedcontentName”: “Contoso Body Care”,
    “type”: “VIDEO”
  }]
}
```

An example meta tag suitable for insertion in the DOM of a webpage is shown below, and is based on a fully escaped and minified version of the schema (Example JSON Minified and Escaped Provider Metadata Meta Tag) shown above:

<meta name=“ContentMetadata” content=“{\“atps\”:[{\“idType\” :\“IAB_GVL_ID\”,\“id\” :
2,\“name\” : “Supply-Side Platform Name\”}, {\“idType\” :\“IAB_GVL_ID\” ,\“id\”:3,
“name\”: “Another Supply-Side Platform Name\”}] ,“targetedcontentPlatform\”:
{\“idType\”:\“IAB_GVL_ID\”,\“id\”:1,\“name\”:\“Demand-Side Platform Name\”
},\“saleCategory\”:{\“device\”:\“DEVICE_USED\”,\“geoLocation\”:\“GEO_LOCATION_
APPROXIMATE\”_{J}\“context\”:\“CONTEXT_USED\”,\“other\”:\“OTHER_NOT_USED\”},\
“targetingCategory\”:{\“geoLocation\”:\“GEO_LOCATION_APPROXIMATE\”,\“remarketingX”:\
“REMARKETING_WEBSITE_VISIT\”,\“userlnterests\”:\“USER_INTERESTS_USED\”,
“userCharacteristics\”:[\“USER_CHARACTERISTICS_GENDER\”,\“USER_CHARACTERISTICS_AGE\
_GROUP\”,\“USER_CHARACTERISTIC_LIFE_STAGE\”],\“context\”:\“CONTEXT_USED\”,\
“lookalike\”:\“LOOKALIKE_SIMILAR_AUDIENCE\”,\“other\”:\“OTHER_NOT_USED\”},\
“targetedcontentinstances\”:[{\“id\”:\“123456789\”,\“targetedcontentDomain\”:\“adomainvalue.com\”,\
“targetedcontentName\”:\“Brand Name\”,\“type\”:\“BANNER\”},{\“id\”,\
“54098375390\”,“targetedcontentDomain\” : \“contoso. com\”,\“targetedcontentName\“:\
“Contoso Body Care\”,\“type\”:\“VIDEO\”}]}”/>

In an embodiment, a single instance of the above shown meta tag may contain more than one set of metadata per content provider. Alternatively, a content provider may provide separate meta tags for each individual piece of targeted content. Separate meta tags may be employed if the metadata is not consistent between two or more items of targeted content of the content provider. For example, a content provider may employ different meta tags where different items of targeted content were targeted at the user based on different user information.

In an embodiment, inclusion of the meta tag with content provider metadata in web page 124, where application 104 is a web browser, or included in or with a targeted content creative provided where application 104 is another type of application, causes application 104 to invoke one or more methods of trusted provider API 106 of application 104 of user device 102 as depicted in FIG. 1. Trusted provider API 106 may comprise a browser API (i.e., a Web API) that is a built-in API of a web browser. Alternatively, trusted provider API 106 may be incorporated into one or more resources to be loaded by the web browser either before or after receipt of the metadata included in targeted content and content provider metadata 144. For example, trusted provider API 106 may comprise a browser extension loaded and enabled by the browser prior to receipt of content provider metadata 144. In another embodiment, trusted provider API 106 may comprise code (e.g., JavaScript code) included in web page 124 that exposes trusted provider API 106 and implements its methods. Alternatively, trusted provider API 106 may be implemented in code or resources to be retrieved from some other location after receiving web page 124 using a link or reference to such code included therein. In any event, trusted provider API 106 is configured to use metadata included in meta tags conforming to a pre-defined schema (e.g., the JSON schema defined herein above) to render GUI 107 to include privacy user interface features. For example, an invocation of or call to one or more interfaces of trusted provider API 106 may include an instruction, either expressly or implicitly, to render GUI 107 to include one or more privacy user interface features corresponding to metadata of content provider metadata 144.

Each object of the example schema shown above will now be described.

atps Object

In an embodiment, for each supply-side platform involved in the sale/auction of this targeted content slot (of which there may be only one), the supply-side platform provides the following data:
idType: defines a type for the id field. idType allows changes to the format of id
id: an identifier for the provider (e.g., an Internet Advertising Bureau (IAB) id number)
name: A friendly text identifier that will be displayed to users and may match the name (e.g., identifier) of the supply-side platform providing this data.

targetedcontentPlatform Object

For the demand-side platform which provided the final targeted content creative (e.g., that won the auction), provide the same fields as the atps object.

saleCategory and targetingCategory Objects

These two objects share the same fields but are separate in purpose. saleCategory identifies the information that the supply-side shared with the demand-side in order to facilitate the targeted content placement. targetingCategory identifies the information that the demand-side used to target the placement to the current user. Participants must provide at least one of these objects according to their role in the context of the current targeted content and what information is accessible to them. The fields and acceptable values for these objects are described as follows:

context—targeted content placement in a web page based on the content of the web page
CONTEXT_NOT_DISCLOSED: Default value. Used when it is unknown or unclear whether context is used for targeting.
CONTEXT_NOT_USED: Used when context is not used for targeting.
CONTEXT_USED: targeting of content is at least partially based on either declared or inferred context.

device—targeted content placement in a web page based on the type of device (e.g., smartphone, tablet, desktop computer, laptop computer) used to request the web page:
DEVICE_NOT_DISCLOSED: Default value. Used when it is unknown or unclear whether device characteristics are used for targeting.
DEVICE_NOT_USED: Used when device characteristics are not used for targeting.
DEVICE_USED: targeted content targeting/sale is at least partially based on device characteristics.

geoLocation—targeted content placement in a web page based on the geographic location of the requesting device:
GEO_LOCATION_NOT_DISCLOSED: Default value. Used when it is unknown or unclear whether geo_location is used for targeting.
GEO_LOCATION_NOT_USED: Used when geo_location is not used for targeting.
GEO_LOCATION_APPROXIMATE: Used when geolocation data is based on either fuzzified latitude-longitude, or IP-derived location.
GEO_LOCATION_PRECISE: Used when geolocation data is precise (e.g., based on a Global Positioning System (GPS) or WiFi fix).
GEO_LOCATION_UNKNOWN_TYPE: Includes cases where both APPROXIMATE and PRECISE are used or where APPROXIMATE or PRECISE cannot be determined.

lookalike—targeted content placement based on similarity of the user to a particular class of users (e.g., as identified by a machine-learning based classifier):
LOOKALIKE_NOT_DISCLOSED: Default value. Used when it is unknown or unclear whether lookalike is used for targeting.
LOOKALIKE_NOT_USED: Lookalike targeting was not used.
LOOKALIKE_SIMILAR_AUDIENCE: Lookalike targeting using a behavioral seed was used.
LOOKALIKE_ID_MATCH: Lookalike targeting using a similarity key (e.g., matching similar customers based on email addresses).

remarketing—typically targeted content placement in a web site based on a prior visit to a different web site:
REMARKETING_NOT_DISCLOSED: : Default value. Used when it is unknown or unclear whether remarketing is used for targeting.
REMARKETING_NOT_USED: Remarketing not used.
REMARKETING_THIRD_PARTY: The targeted content placement is based on online or offline data about the user obtained from someone who may not be the advertiser.
REMARKETING_WEBSITE_VISIT: The targeted content targeting/sale is based on a previous visit to an advertiser's website.
REMARKETING_UNKNOWN_TYPE: Other remarketing types not listed or undetermined.

userCharacteristics—targeted content placement in a web site based on user demographic information:
<empty repeated field=NOT_DISCLOSED>
USER_CHARACTERISTICS_NOT_USED: User characteristics weren't used.
USER_CHARACTERISTICS_GENDER: The targeted content targeting/sale is (partially) based on either declared or inferred gender.
USER_CHARACTERISTICS_AGE_GROUP: The targeted content targeting/sale is (partially) based on either declared or inferred age group.
USER_CHARACTERISTIC_JOB: Information about a user's job was used.
USER_CHARACTERISTIC_INDUSTRY: Information about the industry a user works in was used.
USER_CHARACTERISTIC__INCOME: Information about a user's inferred (or provided) income was used.
USER_CHARACTERISTIC_LIFE_STAGE: Information about a user's inferred (or provided) life stage (e.g., new parent, recent college grad) was used.
USER_CHARACTERISTICS_UNKNOWN_TYPE: Other user characteristics not listed.

userInterests—targeted content placement in a web site based on the interests of the user:
USER_INTERESTS_NOT_DISCLOSED: Default value. Unclear whether user interests are used.
USER_INTERESTS_NOT_USED: User interests weren't used.
USER_INTERESTS_USED: The targeted content targeting/sale is (partially) based on either declared or inferred user interests.

other—targeted content placement based on some other category of user information that does not fit into one of the above definitions:
OTHER_NOT_DISCLOSED: Default value. Unclear whether other information is used.
OTHER_NOT_USED: Other information wasn't used.
OTHER_USED: The targeted content targeting/sale is (partially) based on other information, either declared or inferred.

targetedcontentInstances Object

For each piece of targeted content described by a given set of targeted content provider metadata, all of the following must be provided:
id: an identifier for the targeted content creative. The value should match the value of an id attribute set on the relevant targeted content slot.
targetedcontentDomain: the domain of the content provider associated with the targeted content creative, e.g. “example.com”.
targetedcontentName: optional, recommended field. The name of the advertiser associated with the targeted content creative. If available, a brand name for the specific product advertised (“Contoso Body Care”) is preferred over a brand name for the parent company (“Contoso MegaCorp”), in order to contextualize the targeted content for users.
type: the type of targeted content impression. May take one of the following string values:
   BANNER
   VIDEO
   AUDIO
   NATIVE
   OTHER

Inclusion of further aspects of trusted content providers, such as trusted ad providers, will now be described. In addition to the requirement of furnishing content provider metadata in a predetermined format (e.g., a format that conforms to the schema shown above), trusted content providers may also provide links to two /.well-known/ locations managed by that content provider, in an embodiment. In particular, trusted content providers must maintain a privacy policy at a /.well-known/ location, and further must provide a link to a privacy dashboard at another /.well-known/ location.

Note, the use of the term /.well-known/ location as used herein is intended to be consistent with the Internet Engineering Task Force (IETF) Request for Comments (RFC) 8615 entitled Well-Known Uniform Resource Identifiers (URIs), published Maty 2019. In particular, RFC 8615 sets for a registration standard by which an entity may register a /.well-known/ name as follows. Suppose there is a content provider that owns the example.com domain, and further registers a /.well-known/ URL associated with the term ‘privacy’. Once so registered, one may direct a browser to http://example.com/.well-known/privacy, and the browser will be directed to the URL that was registered for that domain for the term ‘privacy’.

In embodiments, each trusted content provider, therefore, registers a /.well-known/ location for the privacy policy and privacy dashboard, and further, each trusted content provider registers their /.well-known/ location using the same name (i.e., privacy or dashboard) such that one may easily navigate to the associated resources knowing only the base domain for that content provider. Each will be described briefly herein below.

The privacy policy maintained by a content provider may, in an embodiment, include one or more of the following types of exemplary information:
What types of cookies/tracking technologies are being used by the content provider?
What information is collected, how is it used, how is it stored, and for how long is it stored?
How is collected data shared with other companies?
What security measures are taken to protect information?
What choices can users make regarding cookies and tracking technologies, such as opt-out or similar controls?

In embodiments, a privacy dashboard maintained by a content provider at a /.well-known/ location enables one or more of the following exemplary features:
The user may delete or disassociate previously-collected data associated with their identity by the content provider.
This operation is accessible directly from the /.well-known/ location. For example, the user does not need to navigate to a separate document to access the control.
This operation may be achievable in its entirety from the /.well-known/ location. For example, the user does not need to manually contact the content provider to complete the delete/disassociate request.
Enables a user to delete/disassociate data collected from all tracking domains owned by the provider at a single /.well-known/ location.

The specific use cases and integration of links to /.well-known/ locations into GUI 107 will be described in further detail herein below.

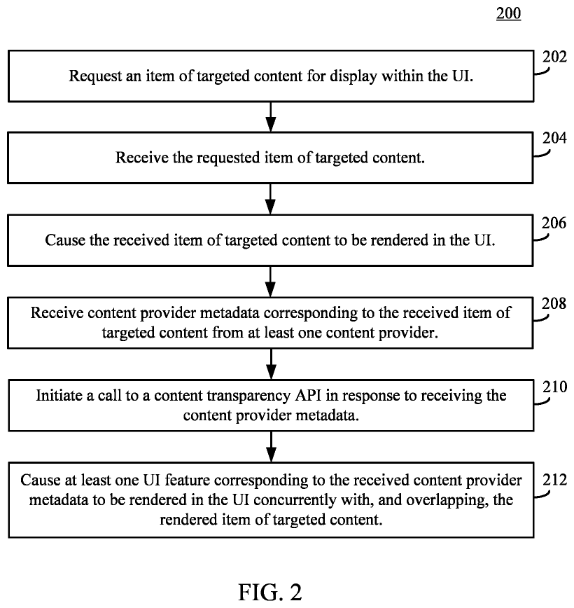

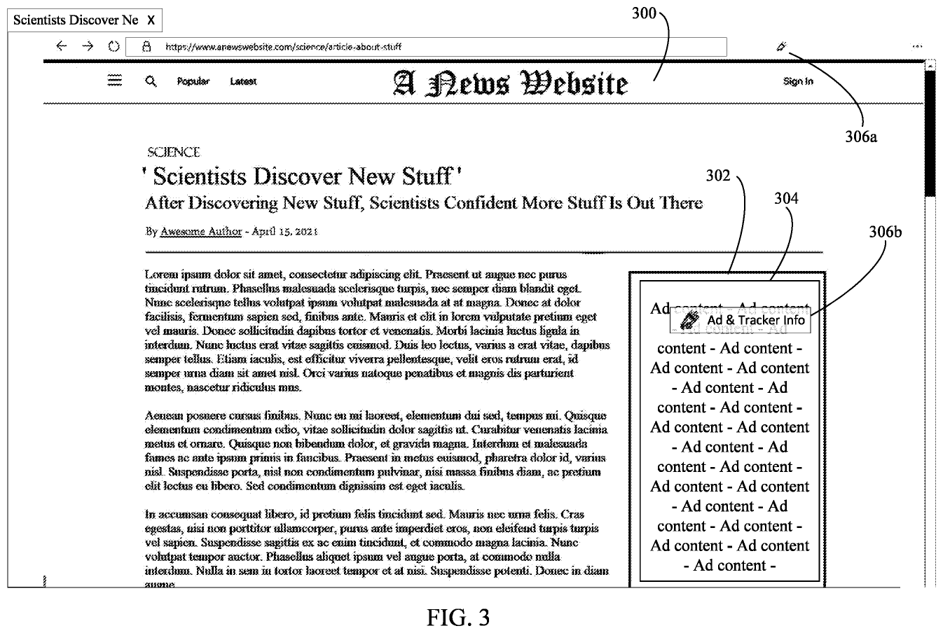

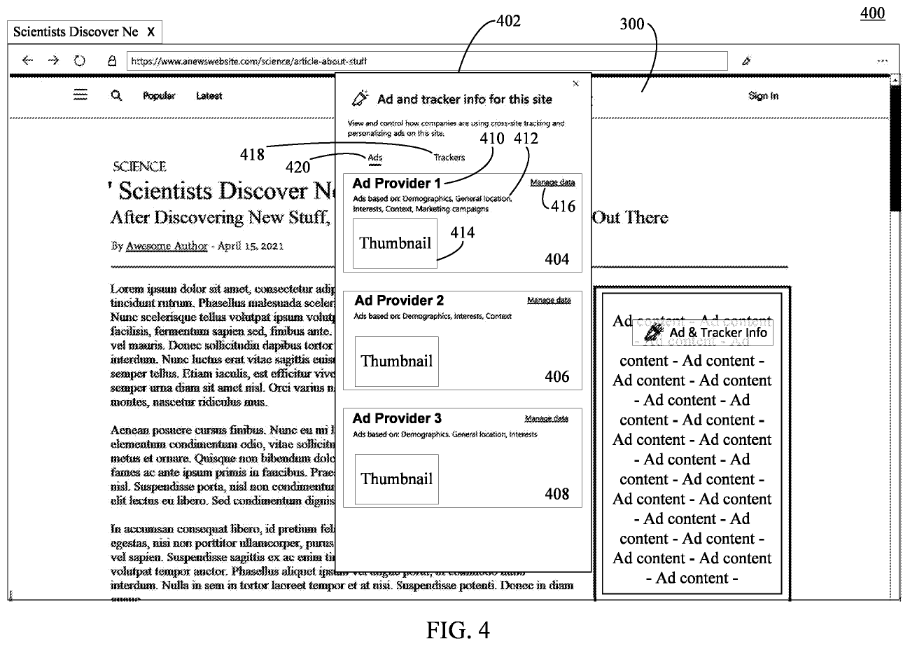

Further operational aspects of targeted content delivery system 100 and user device 102 of FIG. 1 will now be described in conjunction with FIG. 2 which depicts a flowchart 200 of an example method for using a content transparency API to render a UI that includes targeted content UI features, according to an embodiment. Flowchart 200 will be described concurrently with FIG. 3. FIG. 3 depicts an example web page 300 rendered via a content transparency API to include targeted content UI features, according to an embodiment. Thereafter, further aspects of embodiments will be described in the context of FIGS. 4-7 depicting additional UI features. Although described in the context of FIGS. 1 and 3, other structural and operational embodiments will be apparent to persons skilled in the relevant art(s) based on the following discussion regarding flowchart 200 of FIG. 2. Furthermore, although FIG. 3 (and other figures) may be described with respect to targeted content in the form of advertisements, in other embodiments, other forms of targeted content may be used, such as electronic coupons or offers, creative content (e.g., text, audio, images, multimedia), and/or other types of personalized content.

Flowchart 200 begins at step 202. In step 202, an item of targeted content for display within the UI is requested. For example, and with continued reference to targeted content delivery system 100, user device 102 may be configured to operate within targeted content delivery system 100 in the manner described in detail above, in an embodiment. More specifically, where application 104 on user device 102 comprises a web browser, user device 102 may send a page request 122 to publisher 108 and receive page 124 in return, wherein page 124 is configured to permit the dynamic inclusion, and rendering of, targeted content requested from another source. For example, and also as described above, page 124 may cause application 104 to transmit targeted content request 126 to TC server 112.

Alternatively, and as described above, application 104 need not comprise a web browser, and instead may comprise another type of application that is configured to render and display targeted content when the application is executing on user device 102. For example, application 104 may comprise a mobile device app configured to periodically display targeted content for viewing by the user in exchange for the app being provided by, e.g., publisher 108 for free or at a reduced cost. Flowchart 200 of FIG. 4 continues at step 204.

In step 204, the requested item of targeted content is received. For example, and with continued reference to targeted content delivery system 100, user device 102 may be configured to operate within targeted content delivery system 100 in the manner described in detail above, in an embodiment. More specifically, user device 102 may receive an item of targeted content to include in the rendering of page 124 in a number of ways. For example, TC server 112 may be configured to provide targeted content, such as an advertisement in the form of targeted creative content, directly to user device 102 in response to targeted content request 126, and incorporated into targeted content and content provider metadata 144 which is transmitted to user device 102 as described herein above.

Alternatively, any of TC server 112, supply side platform 114, TC exchange 116 or one of DSPs 118-1 to 118-n of demand side platforms 118 may provide a link or reference to user device 102 that points to targeted content creative content stored elsewhere. Thereafter, for example, user device 102 may send request for targeted content 146 to DSP CDN 120 using the link provided previously, and receive targeted content 150 in return. Flowchart 200 continues at step 206.

At step 206, the received item of targeted content is caused to be rendered in the UI. For example, and with continued reference to targeted content delivery system 100, user device 102 may be configured to operate within targeted content delivery system 100 in the manner described in detail above, in an embodiment. In particular, where application 104 comprises a web browser or rendering engine (e.g., Gecko™ used in the Mozilla Firefox® web browser, the WebKit™ engine used by the Apple Safari browser, Trident™ (MSHTML) used in Internet Explorer™, and Blink™ used in the Google Chrome and Microsoft Edge Browsers), and the received item of targeted content is in the form of a targeted content creative (e.g., an HTML frame including targeted content media), application 104 may render the frame in the required location and with the required size within page 124 as displayed on user device 102. Where application 104 comprises a type of application other than a web browser and/or does not include a rendering engine, the received targeted content may be rendered by application 104 by other means (e.g., an external web browser, as playback video-based targeted content using a media player of user device 102). Flowchart 200 continues at step 208.

At step 208, content provider metadata corresponding to the received item of targeted content is received from at least one content provider. For example, and with continued reference to targeted content delivery system 100, user device 102 may be configured to operate within targeted content delivery system 100 in the manner described in detail above, in an embodiment. In particular, one or more of TC server 112, supply side platform 114, TC exchange 116 or one of DSPs 118-1 to 118-n of demand side platforms 118 may generate content provider metadata as described above, and cause same to be delivered to user device 102 as part of targeted content and content provider metadata 140, targeted content and content provider metadata 142 and/or targeted content and content provider metadata 144. Flowchart 200 continues at step 210.

At step 210, a call to a content transparency API is initiated in response to receiving the content provider metadata. For example, and with reference to user device 102 of FIG. 1, application 104 may be provided with or include trusted provider API 106. As described herein above, trusted provider API 106 may include a browser/web API that is a built-in API of the browser, an API loaded by the web browser before any web page is loaded or rendered by the browser (e.g., a browser extension), or an API loaded by the browser in response to loading a page or resources associated therewith. As also described in detail herein above, the receipt of content provider metadata by application 104 at user device 102 signals to application 104 that one or more content providers comprise a trusted provider, which in turn triggers a call to trusted provider API 106. The call includes an instruction, implicit or explicit, to render a UI feature corresponding to metadata of content provider metadata 144. Flowchart 200 concludes at step 212.

At step 212, at least one UI feature corresponding to the received content provider metadata is caused to be rendered in the UI concurrently with, and overlapping, the rendered item of targeted content. For example, and with continued reference to targeted content delivery system 100, the call to trusted provider API 106 performed at step 210 herein above causes (e.g., by an implicit or explicit instruction) application 104 at user device 102 to cause to render at least one UI feature concurrently in the UI with, and overlaying the, rendered item of targeted content. The UI feature may be rendered in any manner described herein, such as by application 104 itself (e.g., by an included web browser and/or rendering engine) or by causing a separate renderer (e.g., a separate web browser or rendering engine) to perform the rendering. For example, consider FIG. 3 which depicts an example web page 300 rendered via a content transparency API to include targeted content UI features, according to an embodiment. As shown in FIG. 3, web page 300 includes a frame 302, targeted content 304 and targeted content UI features 306a and 306b. Other structural and operational embodiments will be apparent to persons skilled in the relevant art(s) based on the following discussion regarding web page 300 as depicted in FIG. 3.

Frame 302 of web page 300 corresponds to a pre-defined area of web page 300 that is configured for placement of suitable targeted content (e.g., a targeted content creative). In embodiments, frame 302 may comprise an html frame or iframe tag/element defined within web page 300. However, such html constructs are merely exemplary, and frame 302 may comprise other types of logical constructs, or may include the entire UI being displayed at that time. For example, frame 302 may encompass the entirety of the UI being rendered on the display where the targeted content comprises a pop-up that is rendered full screen, thereby completely or substantially obscuring any UI that is otherwise associated with the web browser or other application that comprises application 104 of targeted content delivery system 100.

Web page 300 also includes targeted content 304 which is rendered within or coincident with frame 302. In an embodiment, targeted content 304 may comprise the rendering of a targeted content creative (i.e., an object or structure that contains data for visually rendering the targeted content) or other type content comprising the targeted content.

Web page 300 also includes targeted content UI features 306a and 306b. The rendering of each of targeted content UI feature 306a and 306b in web page 300 is similar inasmuch as each comprises or includes an icon (i.e., a stylized megaphone in the present example) that enables access to the transparent targeted content reporting and control features of the embodiments disclosed herein. In embodiments, each of targeted content UI features 306a and 306b functions identically, similarly, or substantially similarly when a user interacts with such features. In particular, clicking on the icon corresponding to targeted content UI feature 306a, or targeted content UI feature 306b which overlays targeted content 304 will present the user with access to the same or similar reporting and control features which may be scoped to include some or all of the targeted content rendered on web page 300. In another embodiment, however, interaction with targeted content UI feature 306b may present reporting and control features that are scoped only to the targeted content over which targeted content UI feature 306b is rendered (and as will be described in more detail below).

Returning now to the description of flowchart 200 of FIG. 2, and with continued reference to web page 300 of FIG. 3, recall that at step 210, in an advertising example, ad provider metadata corresponding to the received targeted content is received from at least one targeted content provider, the content provider metadata causing the application to initiate a call to the content provider transparency API, said call causing the application to render at least one UI feature concurrently in the UI with, and overlaying the, rendered targeted content. Upon receipt of content provider metadata, embodiments of application 104 of user device 102 of FIG. 1 initiate a call to trusted provider API 106 of application 104 which causes each of targeted content UI feature 306a and 306b to be rendered in web page 300, and in particular, for targeted content UI feature 306b to be rendered concurrently with and overlaying targeted content 304 as depicted in FIG. 3.

In the foregoing discussion of steps 202-212 of flowchart 200, it should be understood that at times, such steps may be performed in a different order or even contemporaneously with other steps. Other operational embodiments will be apparent to persons skilled in the relevant art(s). Note also that the foregoing general description of the operation of targeted content delivery system 100 is provided for illustration only, and embodiments of targeted content delivery system 100 may comprise different hardware and/or software, and may operate in manners different than described above. Indeed, user device 102 of targeted content delivery system 100 may be further configured to expose additional content transparency reporting and control features via trusted provider API 106 in response to receiving content provider metadata.

For example, FIG. 4 depicts an example web page 400 rendered to include a content provider information UI 402, according to an embodiment. As shown in FIG. 4, Content provider information UI 402 includes UI features 404, 406 and 408; a provider name 410; a provider ad data 412; a thumbnail 414; a targeted content UI feature 420 and a trackers UI feature 418. Other structural and operational embodiments will be apparent to persons skilled in the relevant art(s) based on the following discussion regarding content provider information UI 402 as depicted in FIG. 4.

With continued reference to FIG. 3, content provider information UI 402 comprises an example UI that may be displayed in response to the user clicking on one of targeted content UI features 306a or 306b as depicted in FIG. 3. Targeted content UI feature 420 and trackers UI feature 418 are features that permit the user to toggle between UI views within content provider information UI 402. For example, the user may click on trackers UI feature 418 to display a trackers UI (as will described further herein below), wherein targeted content UI feature 420 and trackers UI feature 418 remain visible, and wherein clicking on targeted content UI feature 420 will return the user to the UI as depicted in content provider information UI 402.

Each of UI features 404, 406 and 408 includes information that corresponds to a particular ad that is rendered on web page 300. Note, each of the features to be further described in conjunction with UI feature 404 are also present in UI features 406 and 408, but explicit description of each of those such features is omitted for the sake of brevity. it should be noted, however, that the description of the features included in UI feature 404 are equally application to those in UI features 406 and 408.

UI feature 404 includes a provider name 410, provider ad data 412, thumbnail 414, and data management UI feature 416. Provider name 410 is the name of a content provider that provided ad provider metadata, and corresponds to the name object of the atps object of the schema described herein above. Thumbnail 414 of content provider information UI 402 comprises a thumbnail image of the advertisement (i.e., the targeted content creative as rendered and displayed on the page) that corresponds to UI feature 404. With reference to targeted content delivery system 100 of FIG. 1, provider ad data 412 comprises a display of the information that was used by the content provider (i.e., Ad Provider 1 as reflected by provider name 410) to target the user, and that was included in the ad provider metadata received by application 104 at user device 102 as part of targeted content and content provider metadata 144. Last, data management UI feature 416 comprises a link to the provider dashboard at the ad providers /.well-known/ location, and that permits the user to manage the data collected by that ad provider as described herein above.

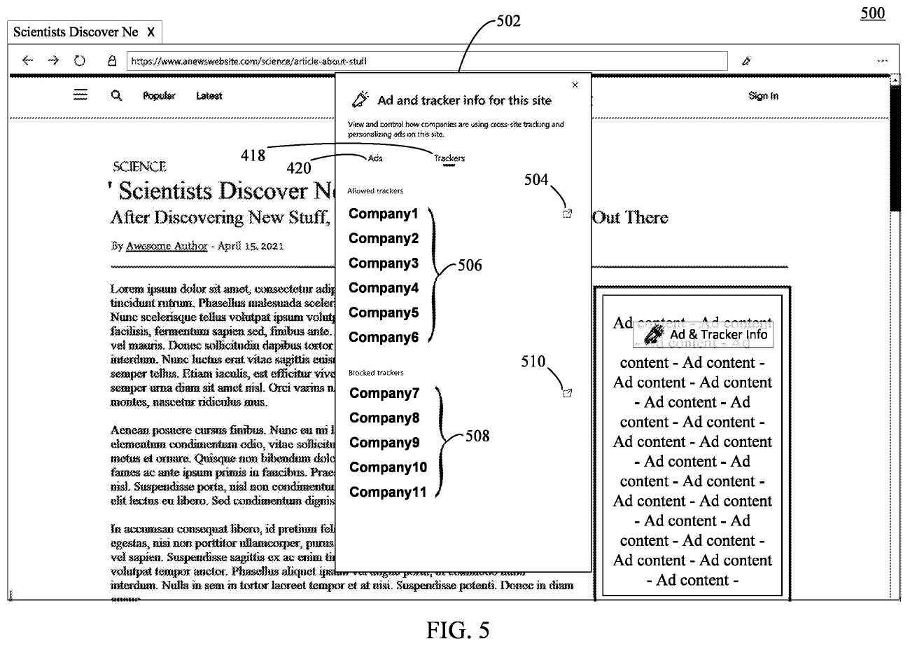

As mentioned above, clicking on trackers UI feature 418 will toggle the UI view to a trackers UI. FIG. 5 depicts an example web page 500 rendered to include a tracker information UI 502, according to an embodiment. As shown in FIG. 5, tracker information UI 502 includes an allowed trackers list 506, a blocked trackers list 508, an allowed trackers detail UI feature 504 and a blocked trackers detail UI feature 510. Tracker information UI 502 also continues to include targeted content UI feature 420 and trackers UI feature 418 as also depicted in FIG. 4. Other structural and operational embodiments will be apparent to persons skilled in the relevant art(s) based on the following discussion regarding tracker information UI 502 as depicted in FIG. 5.

Allowed trackers list 506 comprises a list of trackers that are being permitted to operate by the browser, wherein each tracker corresponds to a company or other entity as identified by their name (e.g., rendered as Company1, Company2, etc. as shown in FIG. 5). Similarly, blocked trackers list 508 comprises a list of the trackers that are currently being blocked. Clicking on the allowed trackers detail UI feature 504 will cause the display of a detailed tracker information UI for the allowed trackers. Likewise, clicking on the blocked trackers detail UI feature 510 will cause the display of a detailed tracker information UI for the blocked trackers.

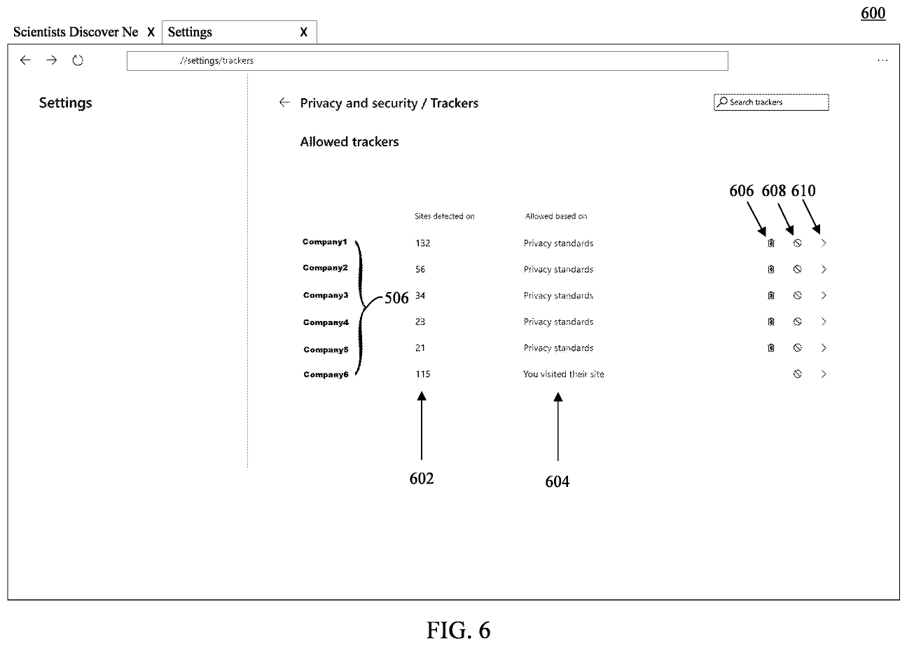

For example, consider FIG. 6 which depicts an example web page 600 rendered to include an allowed trackers detail UI 600, according to an embodiment. As shown in FIG. 6, allowed trackers detail UI 600 includes allowed trackers list 506, a site count UI feature 602 and an allowed basis UI feature 604. Allowed trackers detail UI 600 also includes a delete data UI feature 606, a block tracker UI feature 608 and a dashboard UI feature 610. Other structural and operational embodiments will be apparent to persons skilled in the relevant art(s) based on the following discussion regarding allowed trackers detail UI 600 as depicted in FIG. 6.

Site count UI feature 602 comprises a column in the UI wherein each cell corresponds to the adjacent allowed tracker of allowed trackers list 506, and that shows the number of different web sites on which the respective tracker was detected. Allowed basis UI feature 604 is another column where each cell likewise corresponds to the allowed tracker of that row, and that shows one or more reasons why the tracker is allowed (rather than being blocked). For example, a tracker could be allowed based on the privacy standards being adhered to by the company corresponding to a respective tracker, because the user visited the website, and/or because of one or more settings of the browser itself.

Each allowed tracker in allowed trackers list 506 as depicted in FIG. 6 also has a corresponding delete data UI feature 606, block tracker UI feature 608, and details UI feature 610. Clicking on delete data UI feature 606 in the row of a given tracker will cause the tracker data for that tracker to be deleted, in an embodiment. Clicking on block tracker UI feature 608 in the row of a given tracker will cause that tracker to be blocked thereby preventing the user from being tracked moving forward. Last, clicking on details UI feature 610 in the row of a given tracker will cause a details UI for that tracker to be displayed. In another embodiment, allowed trackers detail UI 600 may include a UI control (e.g., a link) into further details regarding each tracker. In still another embodiment, both allowed and blocked trackers may be shown in a page together. In yet another embodiment, a UI control may be provided for viewing and modifying blocked trackers.

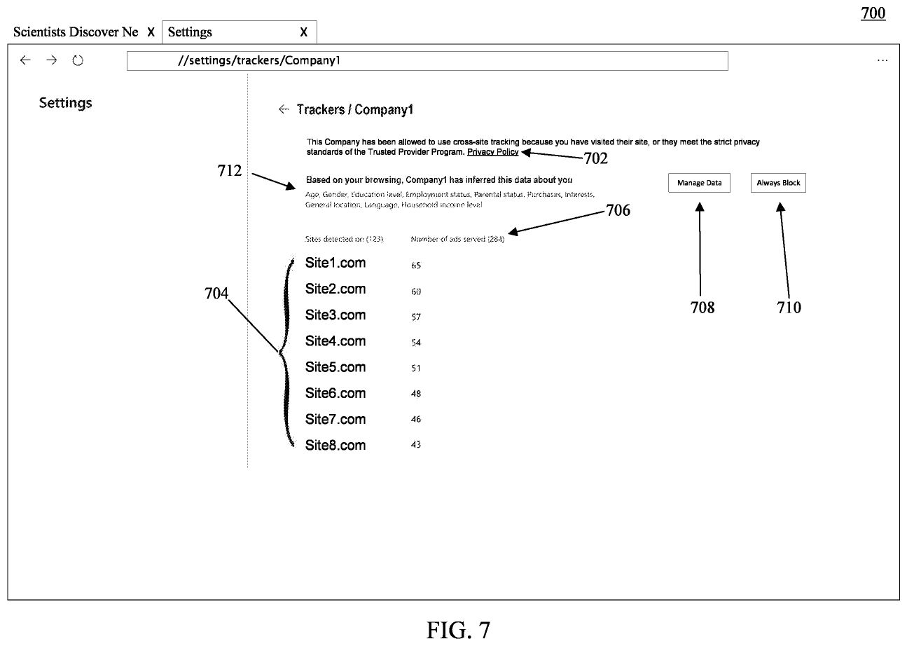

FIG. 7 depicts an example web page comprising a detailed tracker information UI 700, according to an embodiment. As show in FIG. 7, detailed tracker information UI 700 includes a privacy policy link 702, sites list 704, an ad count UI feature 706, a dashboard UI feature 708, a block tracker UI feature 710 and a tracker data feature 712. Other structural and operational embodiments will be apparent to persons skilled in the relevant art(s) based on the following discussion regarding detailed tracker information UI 700 as depicted in FIG. 7.

With reference to FIGS. 5 and 6, and as described above, detailed tracker information UI 700 is displayed in response to a user clicking, for example, the details UI feature 610 of FIG. 6 that corresponds to a tracker of interest (e.g., details UI feature 610 on the row corresponding to Company1 as shown in allowed trackers list 506. Thus, detailed tracker information UI 700 as shown in FIG. 7 is scoped to Company1.

Detailed tracker information UI 700 may include information that the tracker (and its associated company) has, or has inferred, about a user. For example, tracker data feature 712 lists the information that Company1 knows or has inferred about a user based on their browsing history. Detailed tracker information UI 700 also includes sites list 704 which comprises a list of sites on which this particular tracker has been detected, and for each such site, shows in ad count UI feature 706 the number of items of targeted content served by that tracker. Detailed tracker information UI 700 also includes privacy policy link 702 which corresponds to the /.well-known/ privacy policy location, as described herein above, for the respective tracker (i.e., in this case, Company1).

Detailed tracker information UI 700 also includes features that permit a user to perform management and control actions. For example, detailed tracker information UI 700 includes dashboard UI feature 708 which, when clicked, causes the UI to display the data management dashboard for the respective tracker, by loading pages and/or resources from the /.well-known/ dashboard location, as also described herein above, for the respective tracker (i.e., Company1). Further, detailed tracker information UI 700 also provides block tracker UI feature 710 that enables a user to block the tracker to prevent the user from be tracked going forward. In another embodiment, block tracker UI feature 710 is not present, and instead, in allowed trackers detail UI 600 of FIG. 6, a UI control may be present that when interacted with blocks all transparent content providers that do not also meet other criteria for unblocking.

### III. EXAMPLE MOBILE DEVICE IMPLEMENTATION

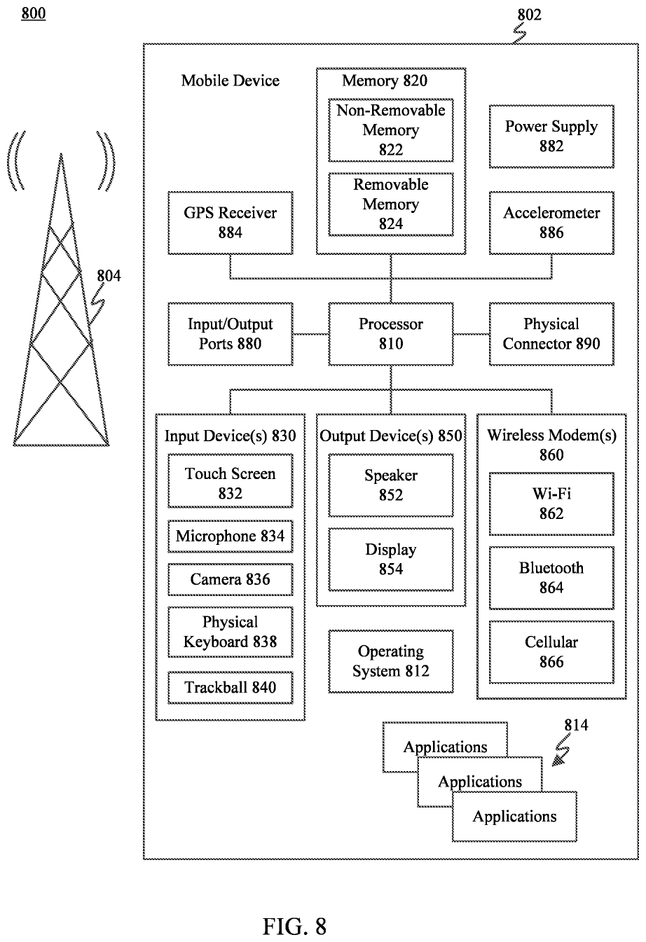

FIG. 8 is a block diagram of an exemplary mobile device 802 that may implement embodiments described herein. For example, mobile device 802 may be used to implement user device 102, and/or any of the components respectively described therein and/or any of the steps of any of flowchart 200. As shown in FIG. 8, mobile device 802 includes a variety of optional hardware and software components. Any component in mobile device 802 can communicate with any other component, although not all connections are shown for ease of illustration. Mobile device 802 can be any of a variety of computing devices (e.g., cell phone, smart phone, handheld computer, Personal Digital Assistant (PDA)) and can allow wireless two-way communications with one or more mobile communications networks 804, such as a cellular or satellite network, or with a local area or wide area network. Mobile device 802 can also be any of a variety of wearable computing device (e.g., a smart watch, an augmented reality headset).

Mobile device 802 can include a controller or processor 810 (e.g., signal processor, microprocessor, ASIC, or other control and processing logic circuitry) for performing such tasks as signal coding, data processing, input/output processing, power control, and/or other functions. An operating system 812 can control the allocation and usage of the components of mobile device 802 and provide support for one or more application programs 814 (also referred to as “applications” or “apps”). Application programs 814 may include common mobile computing applications (e.g., e-mail applications, calendars, contact managers, web browsers, messaging applications) and any other computing applications (e.g., word processing applications, mapping applications, media player applications).

Mobile device 802 can include memory 820. Memory 820 can include non-removable memory 822 and/or removable memory 824. Non-removable memory 822 can include RAM, ROM, flash memory, a hard disk, or other well-known memory devices or technologies. Removable memory 824 can include flash memory or a Subscriber Identity Module (SIM) card, which is well known in GSM communication systems, or other well-known memory devices or technologies, such as “smart cards.” Memory 820 can be used for storing data and/or code for running operating system 812 and application programs 814. Example data can include web pages, text, images, sound files, video data, or other data to be sent to and/or received from one or more network servers or other devices via one or more wired or wireless networks. Memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile device 802 can support one or more input devices 830, such as a touch screen 832, a microphone 834, a camera 836, a physical keyboard 838 and/or a trackball 840 and one or more output devices 850, such as a speaker 852 and a display 854. Other possible output devices (not shown) can include piezoelectric or other haptic output devices. Some devices can serve more than one input/output function. For example, touch screen 832 and display 854 can be combined in a single input/output device. Input devices 830 can include a Natural User Interface (NUI).

Wireless modem(s) 860 can be coupled to antenna(s) (not shown) and can support two-way communications between processor 810 and external devices, as is well understood in the art. Modem(s) 860 are shown generically and can include a cellular modem 866 for communicating with the mobile communication network 804 and/or other radio-based modems (e.g., Bluetooth 864 and/or Wi-Fi 862). At least one of wireless modem(s) 860 is typically configured for communication with one or more cellular networks, such as a GSM network for data and voice communications within a single cellular network, between cellular networks, or between the mobile device and a public switched telephone network (PSTN).

Mobile device 802 can further include at least one input/output port 880, a power supply 882, a satellite navigation system receiver 884, such as a Global Positioning System (GPS) receiver, an accelerometer 886, and/or a physical connector 890, which can be a USB port, IEEE 1594 (FireWire) port, and/or RS-232 port. The illustrated components of mobile device 802 are not required or all-inclusive, as any components can be deleted and other components can be added as would be recognized by one skilled in the art.

In an embodiment, mobile device 802 is configured to implement any of the above-described features of user device 102, and/or any of the components respectively described therein and/or any of the steps of any of flowchart 200. Computer program logic for performing the functions of these devices may be stored in memory 820 and executed by processor 810.

### IV. EXAMPLE COMPUTER SYSTEM IMPLEMENTATION

Each of user device 102, web server 110, TC server 112, supply side platform 114, TC exchange 116, demand side platforms 118, and/or DSP CDN 120, and flowchart 200 may be implemented in hardware, or hardware combined with software and/or firmware. For example, user device 102, web server 110, TC server 112, supply side platform 114, TC exchange 116, demand side platforms 118, and/or DSP CDN 120, and flowchart 200 may be implemented as computer program code/instructions configured to be executed in one or more processors and stored in a computer readable storage medium. Alternatively, user device 102, web server 110, TC server 112, supply side platform 114, TC exchange 116, demand side platforms 118, and/or DSP CDN 120, and flowchart 200 may be implemented as hardware logic/electrical circuitry.

For instance, in an embodiment, one or more, in any combination, of user device 102, web server 110, TC server 112, supply side platform 114, TC exchange 116, demand side platforms 118, and/or DSP CDN 120, and flowchart 200 may be implemented together in a SoC. The SoC may include an integrated circuit chip that includes one or more of a processor (e.g., a central processing unit (CPU), microcontroller, microprocessor, digital signal processor (DSP), one or more graphics processing units (GPUs)), memory, one or more communication interfaces, and/or further circuits, and may optionally execute received program code and/or include embedded firmware to perform functions.

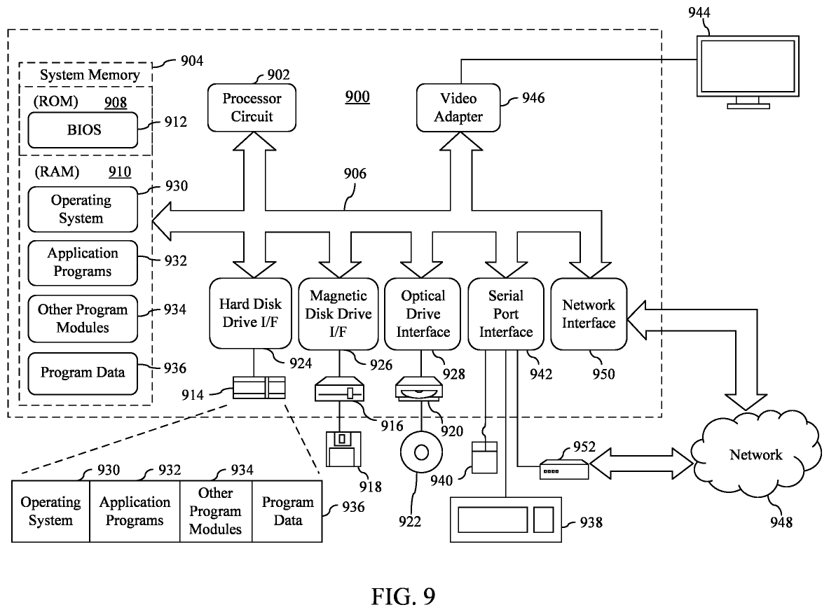

FIG. 9 depicts an exemplary implementation of a computing device 900 in which embodiments may be implemented. For example, user device 138 and server(s) 140 may be implemented in one or more computing devices similar to computing device 900 in stationary or mobile computer embodiments, including one or more features of computing device 900 and/or alternative features. The description of computing device 900 provided herein is provided for purposes of illustration, and is not intended to be limiting. Embodiments may be implemented in further types of computer systems, as would be known to persons skilled in the relevant art(s).

As shown in FIG. 9, computing device 900 includes one or more processors, referred to as processor circuit 902, a system memory 904, and a bus 906 that couples various system components including system memory 904 to processor circuit 902. Processor circuit 902 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 902 may execute program code stored in a computer readable medium, such as program code of operating system 930, application programs 932, other programs 934, etc. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

Computing device 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 930, one or more application programs 932, other programs 934, and program data 936. Application programs 932 or other programs 934 may include, for example, computer program logic (e.g., computer program code or instructions) for implementing user device 102, web server 110, TC server 112, supply side platform 114, TC exchange 116, demand side platforms 118, and/or DSP CDN 120, and flowchart 200 (including any suitable step of flowchart 200), and/or further embodiments described herein.

A user may enter commands and information into the computing device 900 through input devices such as keyboard 938 and pointing device 940. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 902 through a serial port interface 942 that is coupled to bus 906, but may be connected by other interfaces, such as a parallel port, game port, or a universal serial bus (USB).

A display screen 944 is also connected to bus 906 via an interface, such as a video adapter 946. Display screen 944 may be external to, or incorporated in computing device 900. Display screen 944 may display information, as well as being a user interface for receiving user commands and/or other information (e.g., by touch, finger gestures, virtual keyboard). In addition to display screen 944, computing device 900 may include other peripheral output devices (not shown) such as speakers and printers.

Computing device 900 is connected to a network 948 (e.g., the Internet) through an adaptor or network interface 950, a modem 952, or other means for establishing communications over the network. Modem 952, which may be internal or external, may be connected to bus 906 via serial port interface 942, as shown in FIG. 9, or may be connected to bus 906 using another interface type, including a parallel interface.

As used herein, the terms “computer program medium,” “computer-readable medium,” and “computer-readable storage medium” are used to refer to physical hardware media such as the hard disk associated with hard disk drive 914, removable magnetic disk 918, removable optical disk 922, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 932 and other programs 934) may be stored on the hard disk, magnetic disk, optical disk, ROM, RAM, or other hardware storage medium. Such computer programs may also be received via network interface 950, serial port interface 942, or any other interface type. Such computer programs, when executed or loaded by an application, enable computing device 900 to implement features of embodiments described herein. Accordingly, such computer programs represent controllers of the computing device 900.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### V. ADDITIONAL EXAMPLE EMBODIMENTS

A method in an application configured to cause display of a user interface (UI) on a display device associated with a computing device is provided herein. The method comprising: requesting an item of targeted content for display within the UI; receiving the requested item of targeted content; causing the received item of targeted content to be rendered in the UI; receiving content provider metadata corresponding to the received item of targeted content from at least one content provider; initiating a call to a content transparency application programming interface (API) in response to receiving the content provider metadata, the call including an instruction to render at least one UI feature in the UI corresponding to the received content provider metadata; and causing, by the call, the at least one UI feature to be rendered in the UI concurrently with, and overlaying, the rendered item of targeted content.

In another embodiment of the foregoing method, the method further comprises: in response to detecting interaction by a user with the at least one UI feature, causing the application to display a second UI feature that identifies: the at least one content provider; information corresponding to the user that formed the basis for a bid request; information corresponding to the user that was used to target the user for an impression of the received item of targeted content; or how information corresponding to the user was acquired by the at least one content provider.

In another embodiment of the foregoing method, the second UI feature includes a third UI feature configured to enable the user to manage the use of information corresponding to the user by the at least one content provider.

In another embodiment of the foregoing method, the application comprises a web browser and the UI is associated with a web page requested by and subsequently rendered by the web browser.

In another embodiment of the foregoing method, the content transparency API comprises one of: a Web API incorporated into the web browser; or an API incorporated into the web page, wherein the web page was generated to include the API.

In another embodiment of the foregoing method, the second UI feature includes a fourth UI feature configured to cause the display of a tracker information UI corresponding to trackers associated with the web page.

In another embodiment of the foregoing method, the tracker information UI includes one or more of: a list allowed trackers; a list of blocked trackers, or one or more UI features that enable a user to: block a tracker; delete all information corresponding to the user managed by an allowed tracker; obtain tracker statistics for an allowed tracker or a blocked tracker; and unblock a tracker.

A system is provided herein. The system comprising: at least one processor circuit; a display device; and at least one memory that stores program code configured to be executed by the at least one processor circuit to perform operations, the operations comprising: causing display of a user interface (UI) on the display device by an application; requesting an item of targeted content for display within the UI; receiving the requested item of targeted content; causing the received item of targeted content to be rendered in the UI; receiving content provider metadata corresponding to the received item of targeted content from at least one content provider; initiating a call to a content transparency application programming interface (API) in response to receiving the content provider metadata, the call including an instruction to render at least one UI feature in the UI corresponding to the received content provider metadata; and causing, by the call, the at least one UI feature to be rendered in the UI concurrently with, and overlaying, the rendered item of targeted content.

In another embodiment of the foregoing system, the operations further comprise: in response to detecting interaction by a user with the at least one UI feature, causing the application to display a second UI feature that identifies: the at least one content provider; information corresponding to the user that formed the basis for a bid request; information corresponding to the user that was used to target the user for an impression of the received item of targeted content; or how information corresponding to the user was acquired by the at least one content provider.

In another embodiment of the foregoing system, the second UI feature includes a third UI feature configured to enable the user to manage the use of information corresponding to the user by the at least one content provider.

In another embodiment of the foregoing system, the application comprises a web browser and the UI is associated with a web page requested by and subsequently rendered by the web browser.

In another embodiment of the foregoing system, the content transparency API comprises one of: a Web API incorporated into the web browser; or an API incorporated into the web page, wherein the web page was generated to include the API.

In another embodiment of the foregoing system, the second UI feature includes a fourth UI feature configured to cause the display of a tracker information UI corresponding to trackers associated with the web page.

In another embodiment of the foregoing system, the tracker information UI includes one or more of: a list allowed trackers; a list of blocked trackers, or one or more UI features that enable a user to: block a tracker; delete all information corresponding to the user managed by an allowed tracker; obtain tracker statistics for an allowed tracker or a blocked tracker; and unblock a tracker.

A computer program product comprising a computer-readable memory device having computer program logic recorded thereon that when executed by at least one processor of a computing device causes the at least one processor to perform operations implementing an application is provided herein. The operations comprise: causing display of a user interface (UI) on a display device associated with the computing device; requesting an item of targeted content for display within the UI; receiving the requested item of targeted content; causing the received item of targeted content to be rendered in the UI; receiving content provider metadata corresponding to the received item of targeted content from at least one content provider; initiating a call to a content transparency application programming interface (API) in response to receiving the content provider metadata, the call including an instruction to render at least one UI feature in the UI corresponding to the received content provider metadata; and causing, by the call, the at least one UI feature to be rendered in the UI concurrently with, and overlaying, the rendered item of targeted content.

In another embodiment of the foregoing computer program product, the operations further comprise: in response to detecting interaction by a user with the at least one UI feature, causing the application to display a second UI feature that identifies: the at least one content provider; information corresponding to the user that formed the basis for a bid request; information corresponding to the user that was used to target the user for an impression of the received item of targeted content; or how information corresponding to the user was acquired by the at least one content provider.

In another embodiment of the foregoing computer program product, the second UI feature includes a third UI feature configured to enable the user to manage the use of information corresponding to the user by the at least one content provider.

In another embodiment of the foregoing computer program product, the application comprises a web browser and the UI is associated with a web page requested by and subsequently rendered by the web browser.

In another embodiment of the foregoing computer program product, the second UI feature includes a fourth UI feature configured to cause the display of a tracker information UI corresponding to trackers associated with the web page.

In another embodiment of the foregoing computer program product, the tracker information UI includes one or more of: a list allowed trackers; a list of blocked trackers, or one or more UI features that enable a user to: block a tracker; delete all information corresponding to the user managed by an allowed tracker; obtain tracker statistics for an allowed tracker or a blocked tracker; and unblock a tracker.

### VI. CONCLUSION

While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed is:

1. A method in an application configured to cause display of a user interface (UI) on a display device associated with a computing device, comprising:
requesting an item of targeted content for display within the UI;
receiving the requested item of targeted content;
causing the received item of targeted content to be rendered in the UI;
receiving content provider metadata corresponding to the received item of targeted content from at least one content provider;
initiating a call to a content transparency application programming interface (API) in response to receiving the content provider metadata, the call including an instruction to render at least one UI feature in the UI corresponding to the received content provider metadata; and
causing, by the call, the at least one UI feature to be rendered in the UI concurrently with, and overlaying, the rendered item of targeted content.

2. The method of claim 1 further comprising:
in response to detecting interaction by a user with the at least one UI feature, causing the application to display a second UI feature that identifies:
the at least one content provider;
information corresponding to the user that formed the basis for a bid request;
information corresponding to the user that was used to target the user for an impression of the received item of targeted content; or
how information corresponding to the user was acquired by the at least one content provider.

3. The method of claim 2, wherein the second UI feature includes a third UI feature configured to enable the user to manage the use of information corresponding to the user by the at least one content provider.

4. The method of claim 1, wherein the application comprises a web browser and the UI is associated with a web page requested by and subsequently rendered by the web browser.

5. The method of claim 4, wherein the content transparency API comprises one of:
a Web API incorporated into the web browser; or
an API incorporated into the web page, wherein the web page was generated to include the API.

6. The method of claim 4, wherein the second UI feature includes a fourth UI feature configured to cause the display of a tracker information UI corresponding to trackers associated with the web page.

7. The method of claim 6, wherein the tracker information UI includes one or more of:
a list allowed trackers;
a list of blocked trackers, or
one or more UI features that enable a user to:
block a tracker;
delete all information corresponding to the user managed by an allowed tracker;
obtain tracker statistics for an allowed tracker or a blocked tracker; and
unblock a tracker.

8. A system comprising:
at least one processor circuit;
a display device; and
at least one memory that stores program code configured to be executed by the at least one processor circuit to perform operations, the operations comprising:
causing display of a user interface (UI) on the display device by an application;
requesting an item of targeted content for display within the UI;
receiving the requested item of targeted content;
causing the received item of targeted content to be rendered in the UI;
receiving content provider metadata corresponding to the received item of targeted content from at least one content provider;
initiating a call to a content transparency application programming interface (API) in response to receiving the content provider metadata, the call including an instruction to render at least one UI feature in the UI corresponding to the received content provider metadata; and
causing, by the call, the at least one UI feature to be rendered in the UI concurrently with, and overlaying, the rendered item of targeted content.

9. The system of claim 8, the operations further comprising:
in response to detecting interaction by a user with the at least one UI feature, causing the application to display a second UI feature that identifies:
the at least one content provider;
information corresponding to the user that formed the basis for a bid request;
information corresponding to the user that was used to target the user for an impression of the received item of targeted content; or
how information corresponding to the user was acquired by the at least one content provider.

10. The system of claim 9, wherein the second UI feature includes a third UI feature configured to enable the user to manage the use of information corresponding to the user by the at least one content provider.

11. The system of claim 8, wherein the application comprises a web browser and the UI is associated with a web page requested by and subsequently rendered by the web browser.

12. The system of claim 11, wherein the content transparency API comprises one of:
a Web API incorporated into the web browser; or
an API incorporated into the web page, wherein the web page was generated to include the API.

13. The system of claim 11, wherein the second UI feature includes a fourth UI feature configured to cause the display of a tracker information UI corresponding to trackers associated with the web page.

14. The system of claim 13, wherein the tracker information UI includes one or more of:
a list allowed trackers;
a list of blocked trackers, or
one or more UI features that enable a user to:
block a tracker;
delete all information corresponding to the user managed by an allowed tracker;
obtain tracker statistics for an allowed tracker or a blocked tracker; and
unblock a tracker.

15. A computer program product comprising a computer-readable memory device having computer program logic recorded thereon that when executed by at least one processor of a computing device causes the at least one processor to perform operations implementing an application, the operations comprising:
causing display of a user interface (UI) on a display device associated with the computing device;
requesting an item of targeted content for display within the UI;
receiving the requested item of targeted content;
causing the received item of targeted content to be rendered in the UI;
receiving content provider metadata corresponding to the received item of targeted content from at least one content provider;
initiating a call to a content transparency application programming interface (API) in response to receiving the content provider metadata, the call including an instruction to render at least one UI feature in the UI corresponding to the received content provider metadata; and
causing, by the call, the at least one UI feature to be rendered in the UI concurrently with, and overlaying, the rendered item of targeted content.

16. The computer program product of claim 15, wherein the operations further comprise:
in response to detecting interaction by a user with the at least one UI feature, causing the application to display a second UI feature that identifies:
the at least one content provider;
information corresponding to the user that formed the basis for a bid request;
information corresponding to the user that was used to target the user for an impression of the received item of targeted content; or
how information corresponding to the user was acquired by the at least one content provider.

17. The computer program product of claim 16, wherein the second UI feature includes a third UI feature configured to enable the user to manage the use of information corresponding to the user by the at least one content provider.

18. The computer program product of claim 15, wherein the application comprises a web browser and the UI is associated with a web page requested by and subsequently rendered by the web browser.

19. The computer program product of claim 18, wherein the second UI feature includes a fourth UI feature configured to cause the display of a tracker information UI corresponding to trackers associated with the web page.

20. The computer program product of claim 19, wherein the tracker information UI includes one or more of:
a list allowed trackers;
a list of blocked trackers, or
one or more UI features that enable a user to:
block a tracker;
delete all information corresponding to the user managed by an allowed tracker;
obtain tracker statistics for an allowed tracker or a blocked tracker; and
unblock a tracker.
